(19) United States
(12) Patent Application Publication
(10) Pub. No.: US 2024/0335967 A1
(43) Pub. Date: Oct. 10, 2024

(54) SLICING MACHINE WITH PARKING POSITION FOR GRIPPER

(71) Applicant: MULTIVAC SEPP HAGGENMÜLLER SE & CO. KG, Wolfertschwenden (DE)

(72) Inventors: Daniel HONOLD, Marktoberdorf (DE); David BÖTTCHER, Darmstadt (DE)

(73) Assignee: MULTIVAC SEPP HAGGENMÜLLER SE & CO. KG, Wolfertschwenden (DE)

(21) Appl. No.: 18/627,288

(22) Filed: Apr. 4, 2024

(30) Foreign Application Priority Data
Apr. 5, 2023 (DE) 102023108709.6

(51) Int. Cl. B26D 7/06; B26D 5/00; B26D 7/22

(52) U.S. Cl. CPC B26D 7/0633; B26D 5/00; B26D 7/225; B26D 2210/02

(57) ABSTRACT

In order to avoid having to remove grippers that are not required from the machine when changing the number of lanes by disconnecting the supply lines, in particular pneumatic lines (which requires a great deal of effort due to the hygiene regulations when reconnecting later) the gripper that is not required, at least its base part, ideally together with the gripper head fastened to the base part, is removed from the operating position and repositioned to a parking position without having to disconnect the supply lines. The same is also optionally possible with the contact pressing units of the PFOs, whose contact pressing drives are also connected to supply lines, usually pneumatic lines.

### CROSS-REFERENCE TO RELATED APPLICATIONS

This application claims foreign priority benefits under 35 U.S.C. § 119 (a)-(d) to German patent application number DE 102023108709.6, filed Apr. 5, 2023, which is incorporated by reference in its entirety.

### TECHNICAL FIELD

The disclosure relates to multilane slicing machines, in particular so-called “slicers”, with which strands of an only slightly compressible product, such as sausage or cheese, are sliced in the food industry.

### BACKGROUND

Since these strands can be produced with a cross-section that retains its shape and dimensions well over its length, i.e. substantially constant, they are called product logs.

Several product logs arranged in parallel on different lanes next to one another are sliced simultaneously by the same blade, which moves in a transverse direction to the longitudinal direction of the product logs, cutting off one slice at a time in one pass.

The product logs are transported forwards by a feed conveyor of a feeding unit in the direction of the blade of the slicing unit, usually on an obliquely downwardly directed feed conveyor, usually a driven endlessly revolving feeding belt, and are each guided through the product openings of a plate-shaped, so-called slicing frame, at the front end of which the part of the product log projecting beyond it is cut off as a slice by the blade directly in front of the slicing frame.

The slices usually drop onto a discharge conveyor of a discharge unit, by means of which they are transported away for further processing.

During slicing, the product logs are usually held at their rear end facing away from the slicing frame by a gripper, which is equipped with corresponding gripper claws for this purpose.

Due to possible compression or elongation of the logs, which are often several metres long, a driven upper and/or lower product guide each with one control belt per lane that can be driven in a controlled manner is present in addition in the vicinity of the slicing unit, said upper and/or lower product guide being adjacent to the upper side or lower side of the log and feeding it to the slicing unit at the correct speed and step size, while the feed conveyor only provides the coarse feed.

To reload the slicer with new product logs, the feed conveyor can usually be folded down from the oblique slicing position to a horizontal loading position for easier loading.

This can already take place, while the slicing of the remainder of the old product logs (which are still being transported and held by the grippers and the upper and/or lower product guide) is being completed.

After this has taken place, the remaining piece that can no longer be sliced is removed from the grippers, which move away from the slicing unit to their starting position at a maximum distance therefrom, so that when the newly loaded feed conveyor is pivoted upward, the grippers are again located behind the rear ends of the new product logs and can grip them.

If the slicing machine is to be used very variably, it is a lane-individually controllable slicing machine.

If the number of lanes and/or the lane spacing is changed, all parts of the feeding unit, i.e. gripper, upper and/or lower product guide, must be adjusted accordingly.

The lower feeding belt, on which the logs rest, is usually a continuously wide conveyor belt across all lanes, but if these are also individual adjacent feeding belts, this also applies to these feeding belts, which can then usually be controlled individually for each lane.

When changing the number of lanes and/or the lane spacing, there is the problem that some parts of the feeding unit should then be removed from the machine, but are suspended from supply lines, for example the activator for the respective gripper and the other unit for the upper product guide.

However, due to the existing hygiene regulations, the decoupling from these supply lines and, above all, the later recoupling requires a great deal of work and time, which leads to a long downtime of the machine during changeover and also poses a hygiene risk.

In addition, the parts removed from the machine as required, the so-called “vario parts”, then have to be temporarily stored outside the machine, but as close to the machine as possible, under appropriately hygienic conditions, which increases the space required for the slicing machine.

### SUMMARY

It is therefore the object according to the disclosure to provide a slicing machine, in particular with a feeding unit and in particular its gripper unit, which avoids the problems mentioned and, despite its simple design, requires a small number of different assemblies and enables quick installation and removal, as well as a method for operating such a slicing machine.

A multilane slicing machine of the type in question, in particular a slicer, has several assemblies, namely
a slicing unit having a rotating blade,
a feeding unit for feeding a plurality of logs arranged next to one another in a first transverse direction in a feed direction to the slicing unit,
a controller for controlling moving parts of this slicing machine.

In this case, the feeding unit comprises a lower support, in particular in the form of a lower, endlessly revolving feeding belt, on which the log rests, as well as a gripper unit with a gripper carriage with one or more operating gripper receptacles, to which a plurality of grippers, each connected to at least one supply line, can be fastened in an operating position next to one another in the transverse direction.

Furthermore, at least one upper, driven, so-called product guide, which is present near the slicing unit as a hold-down device for holding the log down and transporting it forwards into the slicing unit in a targeted manner, is usually present, which has at least one upper drivable, endless, revolving hold-down belt, the downward-facing contact run of which is pressed against the upper side of the log.

According to the disclosure, the gripper carriage has at least one parking gripper receptacle, to which one or more grippers can be fastened as a parking position and in which they do not hinder the slicing operation of the machine.

The at least one supply line to each of the grippers is in this case long enough that the gripper can be removed from the operating gripper receptacle, on which it is in the slicing operation, i.e. in use, and can be fastened to the parking gripper receptacle in a parking position.

The supply lines must therefore be long enough and, of course, flexible enough that a gripper, which is connected to its supply line, can be moved from each operating gripper receptacle to each of the parking gripper receptacles, including dismounting and mounting at the corresponding receptacle, without having to disconnect at least one supply line from the gripper for this purpose.

This makes it possible to move the individual grippers from the operating position to the parking position without disconnecting the supply line, which saves a lot of downtime of the machine, especially when reconnecting the supply line and with the necessary hygiene measures.

In this case, the parking gripper receptacle and thus the parking position in the transverse direction are preferably arranged laterally outside the lane region of the slicing machine.

A lane region is understood to be the width region in the transverse direction on which lanes of the slicing machine can be located.

Preferably, the parking gripper receptacle is moved back from the operating gripper receptacle counter to the feed direction and thus the corresponding gripper is also moved counter to the feed direction in the parking position compared to the operating position, which avoids collisions with other machine parts and also logs to be sliced during the slicing operation by grippers that are in the parking position.

In general, each gripper has a gripper base to which a gripper activator is fastened with the aid of which the gripper is activated, i.e., for example, its gripper claws are extended.

The gripper head, i.e. the actual gripper, is attached to the gripper base, usually the front end of the gripper base, which comprises, for example, the gripper claws or other elements, such as a sensing device for sensing a log and the like.

The gripper base is primarily used for fastening to the surrounding components, for example, to one of the gripper receptacles.

Such a gripper receptacle (in particular both the parking gripper receptacle and the operating gripper receptacle) preferably comprises two receptacle parts spaced apart in the feed direction.

The fastening device of the gripper base for fastening to the rear gripper receptacle in the feed direction is preferably hook-shaped, so that the gripper base can be hooked onto the gripper receptacle with this hook at any transverse position of the gripper receptacle.

Preferably, the rear gripper receptacles, in particular if a plurality of grippers, in particular gripper bases, are to be fastened to them next to one another in the transverse direction, are designed as a support rod extending in the transverse direction, in particular with a round cross-section, which makes it easier to hook into the hook-shaped, i.e. U-shaped, fastening device.

The fastening device of the gripper base for the front gripper receptacles preferably comprises a, preferably detachable, latching device.

Preferably, the front gripper receptacle is positioned lower than the rear gripper receptacle, so that after releasing the latching device on the front gripper receptacle, the gripper, in particular the gripper base, hangs downwards from the rear gripper receptacle due to gravity.

Preferably, the gripper head and the gripper base are designed in such a way that the gripper head can be dismounted from the gripper base and also remounted, regardless of whether the gripper base is removed from the machine or mounted in the machine, and regardless of whether it is the parking gripper receptacle or the operating gripper receptacle to which the gripper, in particular the gripper base, is currently fastened.

Preferably, a line channel for accommodating the supply lines to the individual grippers extends in the transverse direction and usually at a distance in the feed direction behind the support plate of the gripper carriage, which is in particular one of the operating gripper receptacles, preferably the front operating gripper receptacle, the line channel being open in at least one direction, preferably upwards, downwards or forwards, when viewed from the side, in order to be able to easily accommodate supply lines therein.

The line channel preferably has passages in its walls for the supply lines at each of the operating positions and/or at each of the parking positions for grippers.

Hold-down device contact pressing drive:

In this case, the upper product guide comprises at least one contact pressing unit, which can be fastened to a hold-down device base body in an operating position, with a contact pressing drive that is connected to at least one supply line. The hold-down device base body has at least one parking contact pressing drive receptacle to which a contact pressing drive, in particular a pneumatic cylinder unit, can be fastened in a parking position, which does not interfere with the slicing operation when it is not currently required.

The supply lines for the contact pressing drives are so long and the parking pressing drive receptacle is arranged, in particular arranged so close to the operating pressing drive receptacles, in such a way that it is possible to move, including mounting and dismounting, a contact pressing drive from each of the operating pressing drive receptacles to the parking pressing drive receptacle without disconnecting its pressing drive supply line.

As a result, high mounting effort is avoided and, in particular, a risk of contamination is avoided.

Preferably, the parking pressing drive receptacle is arranged laterally outside the lane region of the slicing machine in the transverse direction in order to prevent collisions with the logs or other machine parts.

Preferably, the parking pressing drive receptacle is arranged moved back from the operating pressing drive receptacles counter to the feed direction for the same reason.

Preferably, the drive receptacle of the pressing drive has at least one fastening device for fastening to the pressing drive receptacle, in particular a rear fastening device for a rear pressing drive receptacle, which is hook-shaped, so that when the fastening is released relative to the front pressing drive receptacle, the drive receptacle hangs down from the rear pressing drive receptacle due to gravity.

This makes it easy to detach and attach at any transverse position at any time.

Preferably, a line channel extends at a distance in the feed direction behind the front receptacle part in the transverse direction to accommodate the contact pressing supply lines, which, when viewed from the side, is open upwards, downwards or to the front in order to be able to easily insert supply lines into it.

With regard to the procedure for operating such a slicing machine when converting the machine to a smaller number of lanes, a gripper that is no longer required for this purpose is removed from its operating position on an operating gripper receptacle and moved to a parking position on a parking gripper receptacle and fastened without having to disconnect at least one of its supply lines.

The grippers required for the new order are then usually set to the new lane positions in the transverse direction, for which so far it was not necessary to disconnect the supply lines either.

If it is necessary to increase the number of grippers required in operating positions, the procedure is reversed, whereby the machine has a number of operating positions, which corresponds to the maximum number of grippers that can be used simultaneously in the machine.

The contact pressing drives for the upper product guides can also be used in substantially analogous manner.

For this purpose, a contact pressing drive that is currently no longer required is removed from its operating position at an operating pressing drive receptacle and is moved to and fastened in a parking position on a parking pressing drive receptacle without having to disconnect at least one of its supply lines.

The contact pressing drives required for the new application are then usually set to the new lane positions in the transverse direction, for which so far it was not necessary to disconnect the supply lines either.

If it is necessary to increase the number of contact pressing drives required in operating positions, the procedure is reversed, whereby the machine has a number of operating positions, which corresponds to the maximum number of upper product guides that can be used simultaneously in the machine.

### BRIEF DESCRIPTION OF THE DRAWINGS

Embodiments in accordance with the disclosure are described in more detail below by way of example. In the figures:

FIGS. 1a, b: show a slicing machine in the form of a slicer in accordance with the prior art in different perspective views, with an upper product guide as a hold-down device and a feed belt folded up into the slicing position,

FIG. 2a: is a simplified side view of the slicing machine from FIGS. 1a, b, free of trim parts, so that the individual conveyor belts, in particular the upper product guide as a hold-down device for the log, are easier to see, loaded with a product log,

FIG. 2b: is a side view in accordance with FIG. 2a, but with the feed belt folded down into the loading position and the product log sliced except for a log residual piece,

FIG. 3a shows the gripper unit with a gripper guide separately in a perspective representation,

FIG. 3b: is a detail enlargement from FIG. 3a,

FIG. 4a: is a plan view of the gripper unit in a 1st functional position with the gripper latched to the gripper carriage,

FIG. 4b, c: are sections along lines 4B-4B and 4C-4C in FIG. 4a,

FIG. 5a: is a plan view of the gripper unit in a 2nd functional position with the gripper unlatched from the gripper carriage,

FIG. 5b, c: are sections along lines 5B-5B and 5C-5C in FIG. 5a,

FIG. 5cl: is a detail enlargement from FIG. 5c,

FIG. 6a: is a plan view of the gripper unit in a 3rd functional position with the gripper hanging down from the gripper carriage,

FIG. 6b, c: are sections along lines 6B-6B and 6C-6C in FIG. 6a,

FIG. 7a: is a plan view of the gripper unit in a 4th functional position before the gripper engages again,

FIG. 7b, c: are sections along lines 7B-7B and 7C-7C in FIG. 7a,

FIG. 8: is a plan view of an upper product guide according to the disclosure as a hold-down device with only one hold-down device unit mounted,

FIG. 9a: is a section through a hold-down device corresponding to the line 9A-9A in FIG. 8 in the operating position, viewed in the first transverse direction,

FIG. 9b: is a section analogous to FIG. 9a with the pressing drive in the release position.

### DETAILED DESCRIPTION

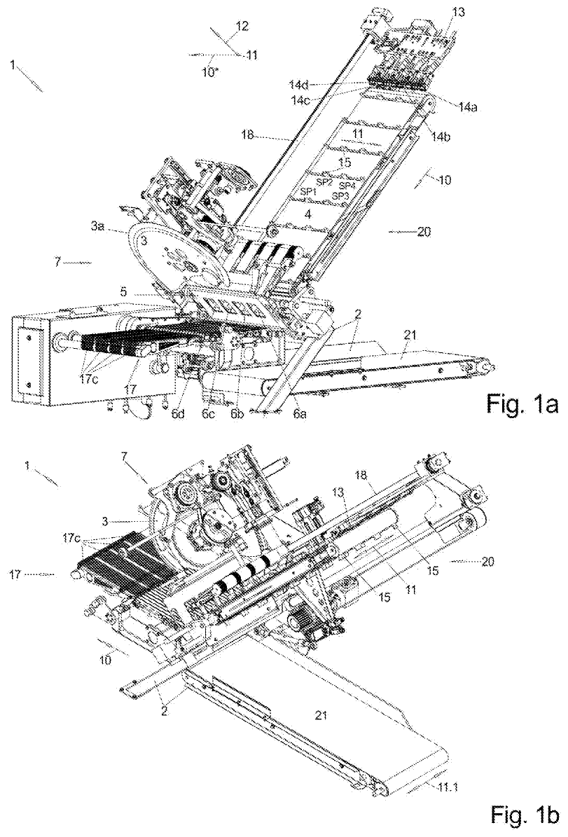

FIGS. 1a, 1b are different perspective views of a multilane slicer 1 for simultaneously slicing a plurality of product logs K each on one lane SP1 to SP4 next to each other and depositing them in shingled portions P each consisting of a plurality of slices S with a general direction of travel 10* through the slicer 1 from right to left.

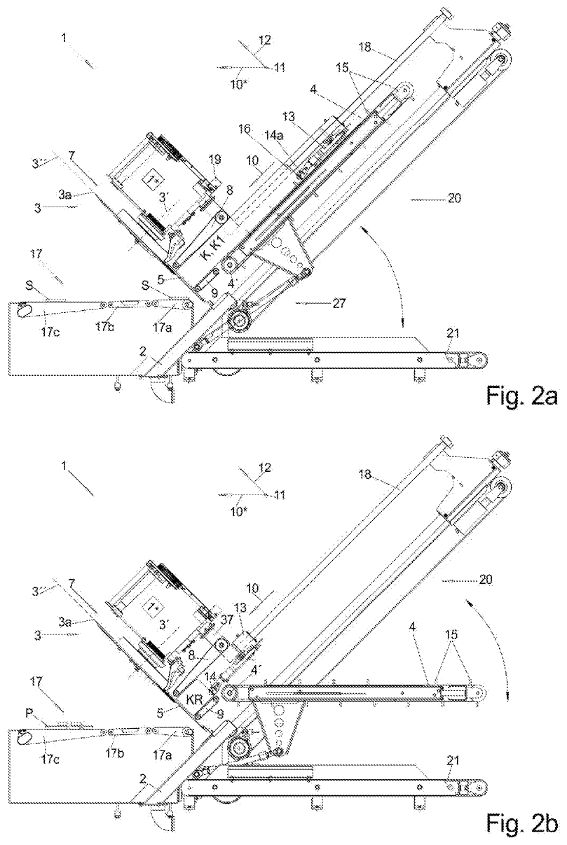

FIG. 2a is (with log K inserted) a side view of this slicer 1, omitting covers and other parts not relevant to the disclosure, which are fastened to the base frame 2 in the same way as all other units, so that the functional parts, especially the conveyor belts, are more clearly visible. The longitudinal direction 10 is the feed direction of the logs K to the slicing unit 7 and thus also the longitudinal direction of the logs K lying in the slicer 1.

It can be seen that the basic structure of a slicer 1 according to the prior art is that a slicing unit 7 with a blade 3 rotating about a blade axis 3′, such as a sickle blade 3, being fed with a plurality of, in this case four, product logs K lying transversely to the feed direction 10 next to one another on a feed conveyor 4 with spacers 15 of the feed conveyor 4 between them are fed by this feeding unit 20, from the front ends of which the rotating blade 3 with its cutting edge 3a cuts off a slice S in each case in one operation, i.e. almost simultaneously.

For slicing the product logs K, the feed conveyor 4 is in the slicing position shown in FIGS. 1a-2a, which is oblique in side view with the slicing side at the front end lying low and the rear end lying high, from which it can be folded down about a pivot axis 20′ extending in its width direction, the first transverse direction 11, which is located in the vicinity of the slicing unit 7, into an approximately horizontal loading position, as shown in FIG. 2b.

According to FIG. 2a, the rear end of each log lying in the feeding unit 20 is held positively by a gripper 14a-d with the aid of gripper claws 16. These grippers 14a-14d, which can be activated and deactivated with regard to the position of the gripper claws 16, are fastened to a common gripper carriage 13, which can be tracked along a gripper guide 18 in the feed direction 10.

In this case, both the feed of the gripper carriage 13 and of the feed conveyor 4 can be driven in a controlled manner, wherein, however, the actual feed speed of the logs K is effected by a so-called upper and lower product guide 8, 9, which is also driven in a controlled manner and which engages the upper side and lower side of the logs K to be sliced in their front end regions, i.e. directly in front of the slicing frame 5 and thus close to the slicing unit 7.

The upper product guide 8 is used as a hold-down device, which presses the log K downwards for resting on the lower product guide 9 opposite the log K, which is used as a counterholder.

Each of the product guides 8, 9 has an endless, revolving hold-down device belt 8A or new 9A, which is driven in a controlled manner in the direction of rotation and which rests with its contact run 8.1 or 9.1 against the upper side or lower side of the log K and transports it forwards in a controlled manner in the feed direction 10.

The front ends of the logs K are each guided through a product opening 6a-d of a plate-shaped slicing frame 5, wherein the slicing plane 3″, in which the blade 3 rotates with its cutting edge 3a and thus cuts off the protrusion of the logs K from the slicing frame 5 as slice S, extends directly in front of the front, obliquely downward pointing end face of the slicing frame 5. The slicing plane 3″ extends perpendicularly to the upper run of the feed conveyor 4 and/or is spanned by the two transverse directions 11, 12 to the feed direction 10.

In this case, the inner circumference of the product openings 6a-d of the cutting edge 3a of the blade 3 serves as a counter-cutting edge.

Since both product guides 8, 9 can be driven in a controlled manner, particularly independently of one another and/or possibly separately for each lane SP1 to SP4, these determine the—continuous or clocked—feed speed of the logs K through the slicing frame 5.

The upper product guide 8 can be displaced in the second transverse direction 12 (which is perpendicular to the feed direction 10 and the 1st transverse direction 11) to adapt to the height H of the log K in this direction. Further, at least one of the product guides 8, 9 can be designed to pivot about one of its deflection rollers in order to be able to change the direction of the contact run of its revolving traction belt 8A, 9A in contact with the log to a limited extent.

The slices S, which are at an angle in the space when they are separated, fall onto a discharge device 17, which starts below the slicing frames 5 and extends in the direction of travel 10*, which in this case consists of a plurality of discharge units 17a, b, c arranged one behind the other with their upper runs approximately aligned in the direction of travel 10*, of which the first discharge unit 17a in the direction of travel 10 can be designed as a portioning belt unit 17a and/or can also be designed as a weighing unit.

The slices S can hit the portioning belt unit 17a individually and spaced apart from one another in the direction of travel 10* or, by appropriate control of the portioning belt 17a of the discharge device 17 (the movement of which, like almost all moving parts, is controlled by the controller 1*) form shingled or stacked portions P by stepwise forward movement or backward movement of the portioning belt 17a.

Below the feed conveyor unit 20, there is usually an approximately horizontally extending residue conveyor 21, which starts with its front end below the slicing frames 5 and directly below or behind the discharge unit 17 and with its upper run thereon transports away dropping residues to the rear by means of the drive of one of the discharge conveyors 17 counter to the direction of travel 10.

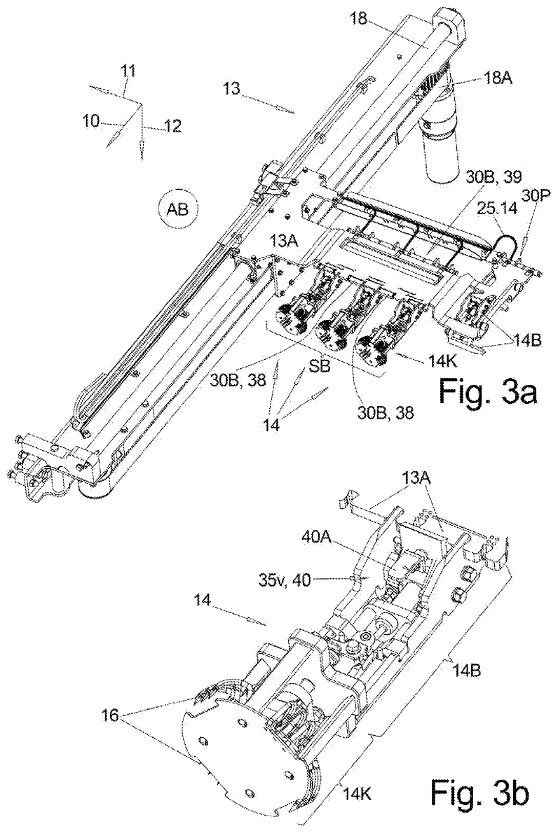

FIG. 3a shows separately only the gripper unit 13 with the plate-shaped gripper carriage 13A, which can be moved along the gripper guide 18 in a controlled manner in the feed direction 10 by means of the endlessly revolving, driven toothed belt 18A.

In the transverse direction 11, the gripper carriage 13A has a plurality of operating gripper receptacles 30B next to one another, on each of which a gripper 14 can be mounted, depending on how many lanes of log K are to be cut open.

Currently, three complete grippers 14 are mounted on the operating gripper receptacles 30B for a 3-lane operation, but as can be seen, there are four operating gripper receptacles 30B.

Such a complete gripper 14 shown separately in FIG. 3b comprises a gripper base 14B (to or in which the gripper activator 14A is also fastened, which extends the gripper claws 16) and the gripper head 14K fastened to the front free end of the gripper base 14B, which also contains the extendable gripper claws 16.

The fourth gripper 14, which is not currently required, is fastened to one of the two parking gripper receptacles 30P, which is arranged as an extension of the gripper carriage 13A in the transverse direction 11 laterally outside the lane region SB, moved back to the rear by approximately half the length of a gripper base 14B relative to the operating gripper receptacles 30B counter to the feed direction 10 and arranged slightly lower in the vertical plane 12.

The operating gripper receptacle 30B has 2 parts and consists, on the one hand, of the front edge of the plate-shaped part of the gripper carriage 13A as the front receptacle part 38 B and, on the other hand, of a support rod 39B as the rear receptacle part 39 B, which is also part of the gripper carriage 13A, but is arranged in the region of the rear edge of the plate-shaped part and at a distance from it.

Accordingly, the fastening device 35 of the gripper base 14B comprises a front fastening device 35v with a latching device 40 for latching to the front receptacle part 38B, in particular the front edge of the gripper carriage 13A, and a rear fastening device 35h in the form of a hook-shaped, i.e. U-shaped, region of the gripper base 14B when viewed in the side view, with which the latter can be hooked onto the support rod 39B and, in particular, into circumferential grooves machined therein when the latching device 40 is released.

The parking gripper receptacles 30P comprise analogous front and rear receptacle parts 38B, whereby the fourth, not required gripper 14 (of which only its gripper base 14B, since the gripper head 14K has been removed) is fastened to the lower side of one of the two parking gripper receptacles 30P analogously to the fastening of the other three grippers 14 under the gripper carriage 13A.

Due to sufficient length of the supply lines 25.14, a gripper 14 that is not currently required can be repositioned from its operating position to a parking position without disconnecting it from its at least one supply line 25.14.

From the gripper bases 14B, in particular from their rear ends, the supply lines 25.14 extend in the transverse direction 11 in a line channel 26,14 (which is also part of the gripper carriage 13A and extends behind its plate-shaped part) to the anti-operator side AB, where they are fed from with a corresponding media source.

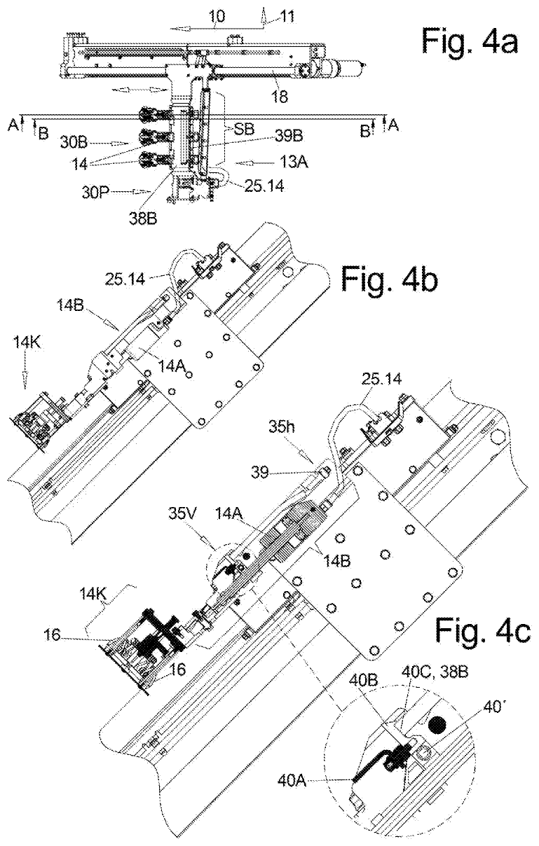

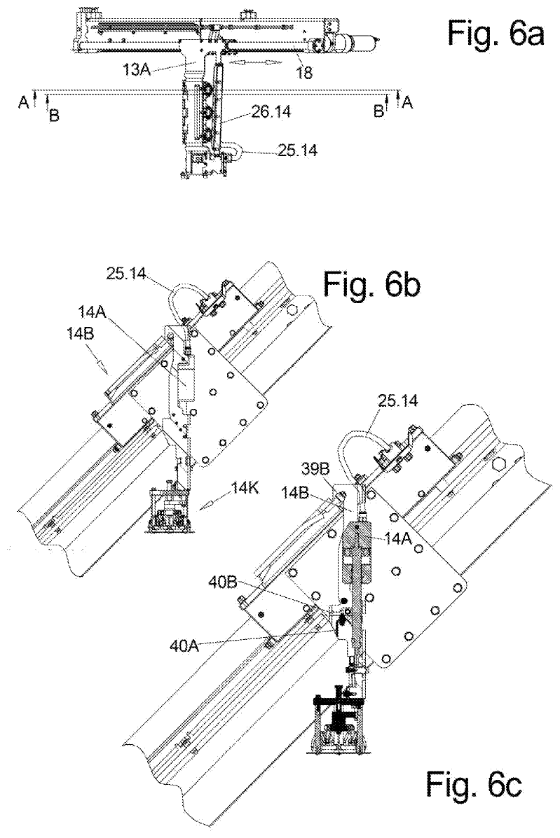

The repositioning process of a gripper 14 from an operating position to a parking position and back is shown in FIGS. 4 to 7, of which FIGS. 4a to 7a each show the gripper unit 13 from FIG. 3a in plan view exactly from above, and FIGS. 4b, c, 5b, c, 6b, c, 7b, c are longitudinal sections along the transverse position indicated in the respective figure, e.g. 4a.

In FIGS. 4-7, the front fastening device 35v of the gripper base 14B for fastening to the front gripper receptacle 38 of the gripper carriage 13A is designed as a latching device 40 and the rear fastening device 35h is designed to be hook-shaped, so that it can be hooked onto a rod-shaped rear gripper receptacle part 39 of the gripper carriage 13A at any transverse position and removed from there, provided that the front fastening device 35 v is released.

Gripper receptacle 38 refers to the operating gripper receptacle 30B as well as to the parking gripper receptacle 30P.

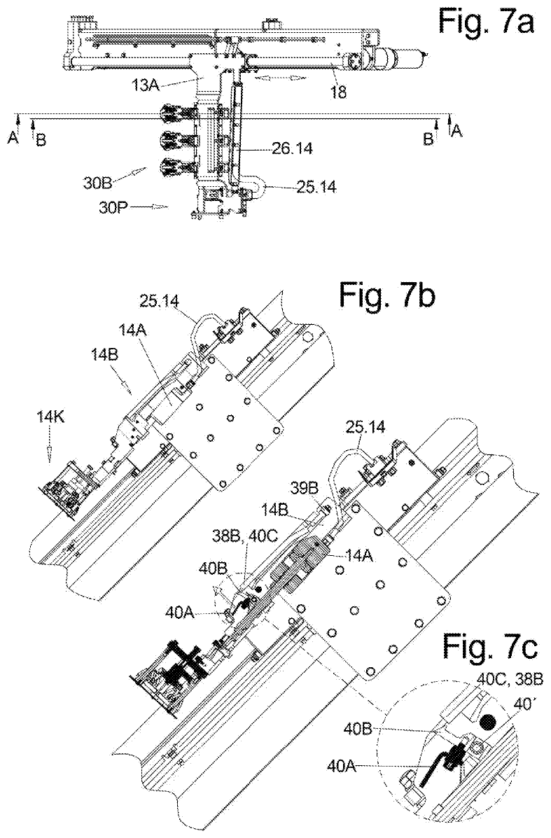

The latching device 40 comprises (as best shown in the detailed enlargements in FIGS. 4c and 7c) a latching lever 40A that is non-rotatably connected to a latching hook 40B, which together can be pivoted about a pivot axis 40′ extending in the transverse direction 11, for example by pressure being exerted on the latching lever 40A by the operator.

The latching hook 40B can latch behind a latching projection 40C of the gripper carriage 13A, which thus simultaneously represents the front gripper receptacle part 38B, as shown in FIGS. 4, in particular FIG. 4c, whereby the gripper base 14B already connected to the gripper carriage 13A by the rear fastening device 35h is fastened to the gripper carriage 13A, be it on an operating gripper receptacle 30B or a parking gripper receptacle 30P.

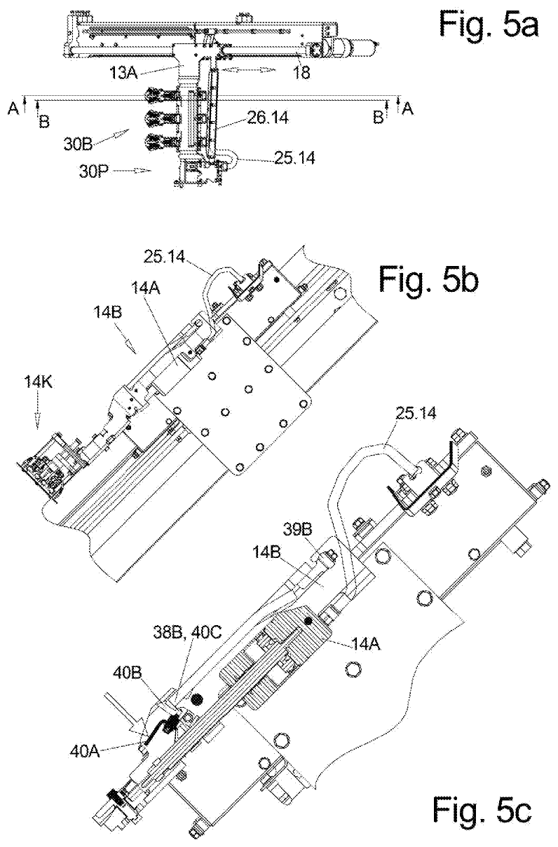

To dismount a gripper base 14B and thus an entire gripper 14 (if a gripper head 14 K is mounted thereon) the operator presses on the latching lever 40A as shown in FIG. 5c, starting from the latched position of FIG. 4, and thereby pivots the latching hook 40B so far that it is out of engagement with the latching projection 40C, i.e. the front receptacle part 38B.

The gripper base 14B, whose rear hook-shaped fastening device 35h is hooked onto the rod-shaped rear gripper receptacle part 39, then pivots downwards about this rod due to gravity and hangs down therefrom.

Now the gripper base 14B can be detached from the rear gripper receptacle part 39, e.g. an operating gripper receptacle 30B, and reattached to another rear gripper receptacle part 39, e.g. a parking gripper receptacle 30P, and all this without having to detach the gripper supply line 25.14 from the gripper base 14B.

As the enlargements in FIGS. 4c, 5c, 6c, 7c show, the gripper activator 14A is a working cylinder, in particular a pneumatic cylinder, which has to be supplied with a corresponding pressure medium, usually compressed air, which is supplied via the supply line 25.14.

Then, as shown in FIGS. 7, the repositioned gripper base 14B can be hooked onto the new rear receptacle part 39 of a gripper receptacle 30 in the same way.

To fasten it to the gripper carriage 13A, the operator only has to pivot the gripper base 14B upwards around the rod-shaped receptacle part 39, as shown in FIG. 7c, until the latching hook 40B latches behind the latching projection 40C. The latching hook 40B is pre-loaded into the latching position, for example by means of a spring (not shown).

The contact pressing drive 33 of an upper product guide 8 also has to be supplied with a form of energy, usually compressed air, for operation via at least one supply line 26.33 in each case.

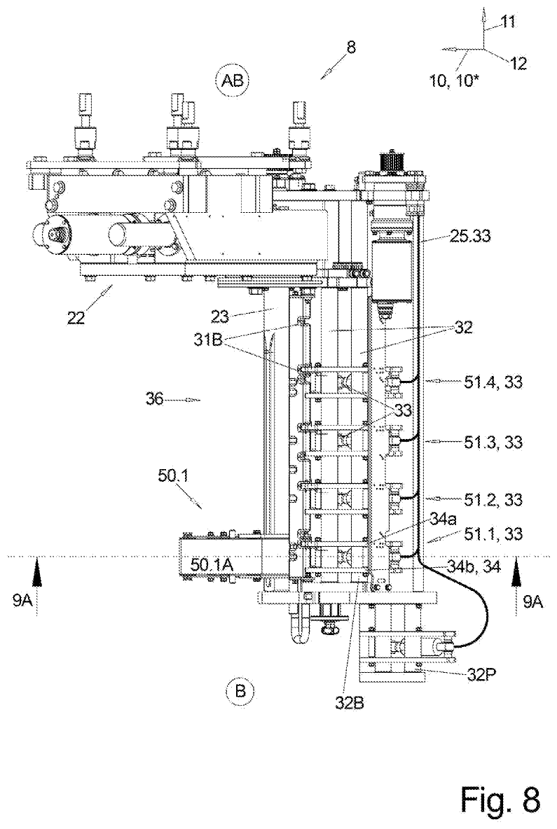

In connection with an OPF and module not currently required and suspended from a supply line 26.33, FIG. 8 shows that the upper product guide 8 has a base body 22, which is located on the anti-operator side AB facing away from the operator and from which a support unit 36 protrudes on one side towards the operator side B across all lanes SP1 to SP4 of the multilane slicer 1 and on this support unit 36 in the 1st transverse direction 11 there are normally mounted next to one another both a plurality of hold-down device units (of which only a single hold-down device unit 50.1 is shown here) and contact pressing units 51.1-51.4, which are respectively assigned to said hold-down device units and aligned thereto in the feed direction 10.

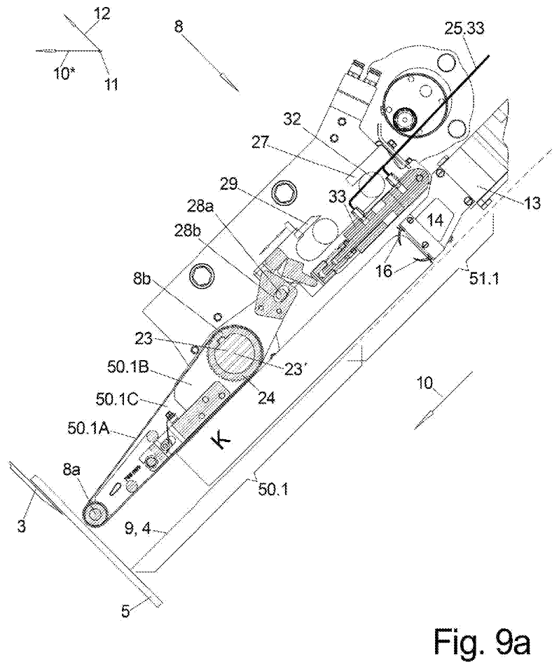

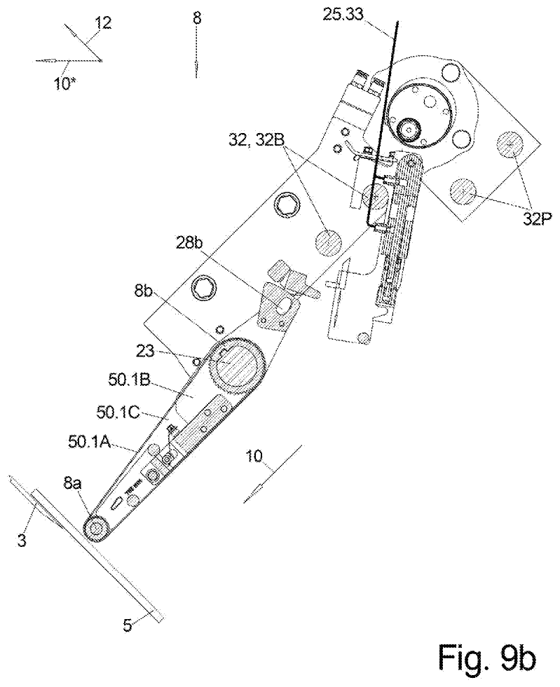

The contact pressing units 51.1-51.4 can be activated and deactivated and require an energy supply for this purpose, usually in the form of compressed air, because the contact pressing drives 33 contained therein are usually pneumatic cylinders, namely pneumatic cylinders acting in both directions, as FIGS. 9a, b show. Accordingly, in the operating state, each of the contact pressing drives 33 of the pressing units 51.1-51.4 is connected to at least one supply line 25.33, so that the same problem exists as with the gripper activators 14A.

From the individual contact pressing drives 33, the supply lines 25.33 are guided in a line channel 26.33 extending in the transverse direction 11, which extends behind or under the two support rods 32, which carry the contact pressing drives 33, to the hold-down device base body 22 and is attached thereto.

The entire support unit 36 can be adjusted in the 2nd transverse direction 12 with the aid of rod guides 37 (see FIG. 2b) in its distance from the base body 22; in particular, it can be adjusted in a controlled manner.

The hold-down device units 50.1, etc., are attached to the common drive shaft 23 and the contact pressing units 51.1-51.4 are attached to two support rods 32 extending parallel thereto.

As can be seen from the sectional view in FIG. 9a viewed in the transverse direction 11, there is also little space upstream of the hold-down belt 50.1A between the upper side of the log K and the hold-down device units 51.1 located above it.

As FIG. 9a shows, the hold-down device unit, e.g. 50.1, has an endless, revolving hold-down device belt 50.1A, which revolves via a deflection roller 8a on the blade side and a deflection roller 8b remote from the blade, which also serves as a drive roller for the belt 50.1A.

For this purpose, the deflection roller 8a serving as the drive roller comprises a drive sleeve 24 that is mounted non-rotatably on a drive shaft 23, which extends in the transverse direction 11 and drives all hold-down device belts of the machine together.

The blade-side deflection roller 8a is mounted in a so-called tensioning flap 50.1C, which can be varied in its distance from a hold-down device base 50.1B, in which the other deflection roller 8b and thus its drive sleeve 24 is mounted, in order to relax the hold-down device belt 50.1A and to be able to remove it easily for cleaning purposes.

The hold-down device belt can be pressed against the log with its front end in the feed direction 10, i.e. the blade-side deflection roller 8a, in which the belt unit can pivot about a pivot axis 23′ extending in the transverse direction 11, in this case the axis of rotation of the drive shaft 23.

This contact pressing is carried out by means of the contact pressing unit 51.1, whose pneumatic cylinder presses eccentrically to the pivot axis 23′ against an extension of the hold-down device base 50.1B extending backwards beyond the pivot axis 23′ in the pivoting direction and thus presses the deflection roller 8a on the other side of the pivot axis 23′ downwards.

The coupling between the contact pressing unit 51.1 and the hold-down device units 50.1 is carried out via a locking pin 28a extending in the transverse direction 11, which is operatively connected to the pneumatic cylinder 33 indirectly, namely via a further pivot lever arranged therebetween, and is accommodated in a recess 28b in the aforementioned extension of the hold-down device base 50.1B.

Thus, depending on the height H in the second transverse direction 12 of the log K, the hold-down device unit 50.1 alone can also be replaced by a differently designed hold-down device unit without having to replace the entire upper product guide 8.

If fewer hold-down device units 50 and thus fewer contact pressing units 51 are required for a new work order than before, it may be that no suitable parking position is available along the support rods 32 (which represent the operating drive receptacles 32B for the contact pressing units 51) for the one or two contact pressing units 51 that are not required due to the dimensions of the logs K and the lane spacing, but instead a parking position is required away from, in particular laterally away from, the lane region in the form of one or more parking drive receptacles 32P.

For this purpose, FIG. 8 shows, viewed in plan view from above, such a parking drive receptacle 32P laterally next to the lane region towards the operator side B and, viewed in plan view, moved back to the rear counter to the feed direction 10, on which a contact pressing units 51 can be accommodated for parking without disconnecting its supply line 25.33.

The pneumatic cylinder 33 of each Andreas unit 51 is accommodated in a cylinder support 34, which comprises two support plates 34a, b spaced apart from one another in the transverse direction 11.

So that each contact pressing unit 51 can be removed from there at any time and transferred to the parking drive receptacle 32P, irrespective of which operating drive receptacle 32B it is located on, the support plates 34a, b (see FIGS. 9a, b) are designed in such a way that they are designed to have the same hook-shaped design in their rear end region, i.e. aligned in transverse direction 11, having a recess open to the front in the feed direction 10, so that they can be hooked with this hook 27 onto the rear of the two support rods 32 at any position in the transverse direction 11 and hang down from there, as shown in FIG. 9b.

For moving it into the operating position, the front end of the cylinder support 34 is pivoted up to the front support rod 32, whereby a latching lever 29, which is fastened to the cylinder support 34 and preferably pre-loaded into the locked position, latches on the upper side of this support rod 32 in such a way that the cylinder supports 34 are latched in a stationary manner on the two support rods 32, i.e. the operating drive receptacle 32B.

The parking drive receptacle 32P visible in FIG. 8b also has two support rods 32 P, so that a contact pressing drive 51 with its cylinder support 34 can be hooked in there in the same way and then latched as a parking position, in which it is then located counter to the feed direction to the rear and in the transverse direction 11 outside the contact pressing units located in the operating position.

Here, it is not necessary to disconnect the supply line 25.33 from the corresponding contact pressing drive 33 of a contact pressing unit 51 in order to reposition from the parking position into the operating position.

As one skilled in the art would understand, the controller 1*, as well an any other unit, machine, apparatus, element, sensor, device, component, system, subsystem, arrangement, or the like described herein may individually, collectively, or in any combination comprise appropriate circuitry, such as one or more appropriately programmed processors (e.g., one or more microprocessors including central processing units (CPU)) and associated memory, which may include stored operating system software and/or application software executable by the processor(s) for controlling operation thereof and/or for performing the particular algorithms represented by the various functions and/or operations (e.g., methods) described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

### LIST OF REFERENCE NUMBERS

1 slicing machine, slicer
1* controller
2 base frame
3 blades
3 axis of rotation
3″ blade plane, slicing plane
3a cutting edge
4 feed conveyor, feed band
5 slicing frame
6a-d product opening
7 slicing unit
8 upper product guide,
8.1 contact run, lower run
8a blade-side deflection roller
8b deflection roller facing away from the blade
9 lower product guide
8.1 contact run, upper run
9a blade-side deflection roller
9b deflection roller facing away from the blade
10 transport direction, feed direction,
10* direction of travel through machine, longitudinal direction of machine
11 1st transverse direction (width slicer)
12 2nd transverse direction (height-direction of log)
13 gripper unit,
13A gripper carriage
14,14.1, 14.2 gripper
14A gripper actuator
14B gripper base
14K gripper head
15 spacer
15′ support surface
16 gripper claw
17 discharge unit
17a, b, c portioning belt, discharge conveyor
18 gripper guide
19 height sensor
20 feed unit
21 residual piece conveyor
22 hold-down device base body
23 drive shaft
23′ pivot axis
24 drive sleeve
25.14,25.33 supply line
26.14,26.33 line channel
27 hook
28a locking pin
28b recess
29 latching lever
30B operating gripper receptacle
30P parking gripper receptacle
31B operating drive receptacles
31P parking drive receptacle
32, 32B, 32P support rod
33 contact pressing drive, pneumatic cylinder unit
34 drive receptacle
35v, h fastening device
36 support unit
37 rod guide
38B, 38P receptacle part
39B, 39P receptacle part
40 latching device
40A latching lever, sensing device
40 B latching hook
40C latching projection
50.1-50.4 hold-down device unit
50.1A-50.4A hold-down belt
50.1B-50.4B hold-down device base
50.1C-50.4C tensioning flap
51.1-51.4 contact pressing units
H log height
K product, product log
KR log rest, residual piece
S slice
SB lane region
P portion
SP1, SP2 lane
V packaging element

1. A multilane slicing machine for slicing logs into slices and producing shingled or stacked portions from slices, the slicing machine comprising:
a slicing unit having a rotating blade,
a feeding unit for feeding a plurality of logs arranged next to one another in the transverse direction relative to the feed direction in the feed direction to the slicing unit,
wherein the feeding unit comprises:
at least one feeding belt lower with respect to the log,
at least one upper product guide hold-down device having at least one upper, drivable hold-down device belt for the log having at least one contact pressing unit, which comprises a contact pressing drive,
a gripper unit having a gripper carriage having one or more operating gripper receptacles, to which a plurality of grippers, each of which is connected to at least one gripper supply line, can be fastened next to one another in the transverse direction in an operating position,
a controller for controlling moving parts of the slicing machine,
wherein
the gripper carriage has at least one parking gripper receptacle to which a gripper can be fastened in a parking position that does not interfere with the slicing operation, and
the supply lines are configured and the parking gripper receptacle is arranged relative to the operating gripper receptacles in such a way to allow movement of, including mounting and dismounting, a gripper from each of the operating gripper receptacles to the parking gripper receptacle without disconnecting its gripper supply line.

2. The slicing machine according to claim 1,
wherein
the parking gripper receptacle is arranged laterally outside the lane region of the slicing machine in the transverse direction and/or
counter to the feed direction, the parking gripper receptacle is arranged back from the operating gripper receptacles.

3. The slicing machine according to claim 1,
wherein
each gripper has a gripper base having a gripper activator and a gripper head fastened to the front end of the gripper base with the gripper claws, and
the gripper base has at least one fastening device for fastening to the gripper receptacle.

4. The slicing machine according to claim 3,
wherein
the operating gripper receptacle and/or the parking gripper receptacle each has a front receptacle part and a rear receptacle part, the front and rear receptacle parts spaced apart in the feed direction.

5. The slicing machine according to claim 4,
wherein
the fastening device has a rear fastening device for the rear gripper receptacle in the shape of a hook, so that, when the fastening is released from the front receptacle part, the gripper base hangs down from the rear receptacle part due to gravity.

6. The slicing machine according to claim 5,
wherein
the fastening device has a front fastening device for the front receptacle part that has a latching device for latching to the front receptacle part,
which, when the front fastening device comes into contact with the front receptacle part, the front fastening device automatically latches onto the front receptacle part.

7. The slicing machine according to claim 5,
wherein
the rear receptacle part is a support rod onto which the gripper base can be hooked with the hook-shaped rear fastening device,
and/or
the front receptacle part is a support plate to which the gripper base can be fastened with the hook-shaped i front fastening device.

8. The slicing machine according to claim 3,
wherein
the gripper head and the gripper base are designed in such a way that the gripper head can be mounted and/or dismounted on the gripper base both when the gripper base is mounted on the parking gripper receptacle and when it is mounted on the operating gripper receptacle.

9. The slicing machine according to claim 3,
wherein
a line channel extends at a distance in the feed direction behind the front receptacle part in the transverse direction for accommodating the gripper supply lines, which channel is open upwards, downwards or forwards when viewed from the side.

10. The slicing machine according to claim 1,
wherein
a hold-down device base body has at least one parking pressing drive receptacle to which a contact pressing drive can be fastened in a parking position that does not interfere with the slicing operation,
the supply lines for the contact pressing drives are configured and the parking pressing drive receptacle is arranged relative to the operating pressing drive receptacles, in such a way that it is possible to move, including mounting and dismounting, a contact pressing drive from each of the operating pressing drive receptacles to the parking pressing drive receptacle without disconnecting its pressing drive supply line.

11. The slicing machine according to claim 10,
wherein
the parking pressing drive receptacle is arranged laterally in the transverse direction outside the lane region of the slicing machine,
and/or
the parking pressing drive receptacle is arranged back from the operating pressing drive receptacles counter to the feed direction.

12. The slicing machine according to claim 11,
wherein
the drive receptacle of the contact pressing drive has at least one fastening device for fastening to the pressing drive receptacle,
wherein the at least one fastening device is a rear fastening device for a rear pressing drive receptacle in the form of a hook, so that when the fastening is released relative to the front pressing drive receptacle, the drive receptacle hangs down from the rear pressing drive receptacle due to gravity.

13. The slicing machine according to claim 12,
wherein
at a distance in the feed direction behind the front receptacle part, a line channel extends in the transverse direction for accommodating the gripper supply lines, which is open upwards, downwards or forwards when viewed from the side.

14. A method for operating a slicing machine having a gripper unit having a gripper carriage with one or more operating gripper receptacles, to which a plurality of grippers, each of which is connected to at least one gripper supply line, can be fastened next to one another in the transverse direction in an operating position,
wherein in the method:
a gripper that is not currently required for the slicing operation is remounted from an operating position to a parking position such that when in the parting position the gripper does not interfere with the slicing operation, and
in this case, the gripper supply line remains connected to the gripper, since the supply lines are configured and the parking position is disposed relative to the operating positions in such a way that it is possible to move, including mounting and dismounting, a gripper from each of the operating positions to the parking position.

15. The method according to claim 14, wherein the slicing machine comprises an upper product guide as a hold-down device having a contact pressing drive,
wherein
the contact pressing drive of the upper product guide that is not currently required for the slicing operation is remounted from an operating position to a parking position that does not interfere with the slicing operation,
in this case, a contact pressing supply line remains connected to the contact pressing drive, since the supply lines are configured and the parking position is disposed relative to the operating positions, in such a way that it is possible to move, including mounting and dismounting, a contact pressing drive from each of the operating positions to the parking position.
